(19) United States
(12) Patent Application Publication
(10) Pub. No.: US 2006/0275519 A1
(43) Pub. Date: Dec. 7, 2006

(54) Plastic tote of cedar-filled material

(76) Inventors: Brian S. Dengler, Rockwall, TX (US); Travis Green, Rockwall, TX (US); Michael Decker, Quinlin, TX (US); Jesse Matola, Winchester, VA (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/431,433

(22) Filed: May 10, 2006

Related U.S. Application Data
(60) Provisional application No. 60/680,165, filed on May 12, 2005.

(51) Int. Cl. A01N 65/00

(52) U.S. Cl. 424/770

(57) ABSTRACT

A tote with insect-repellant properties comprises a base and a sidewall coupled to the base and at least in part defines a tote interior. At least one of the base and the sidewall is constructed from a polymer compound including a polymer and cedar wood. The polymer compound has a ratio of cedar wood to polymer such that the compound is effective to repel insects from within the tote interior.

### CROSS REFERENCE TO RELATED APPLICATIONS

This application claims priority to U.S. Provisional Patent Application No. 60/680,165, filed on May 12, 2005.

### BACKGROUND

1. Technical Field

The present disclosure is generally directed to plastic storage containers, and more particularly to a plastic tote made from cedar-filled material.

2. Description of Related Art

Storage increasingly becomes a priority for homeowners as they accumulate items such as clothing. Especially in northern climates, certain items of clothing such as jackets and sweaters are only used during winter, and the homeowner generally elects to store these items in an out-of-the-way location during warm weather. In other cases, people indefinitely store clothing that is only brought out for special occasions such as weddings or cruises.

A particular problem with storing clothing for a long period of time in an out-of-the-way location is that insects can infest the storage unit and destroy the clothing without the homeowner's knowledge. To address this problem, homeowners have used chests made from aromatic cedar. Aromatic cedar is known for its ability to repel clothing-damaging pests and also its pleasant smell. Cedar chests have long been used to store and protect clothing, especially wool clothing, from damaging bugs such as clothing moths and carpet beetle larva. However, cedar chests may be expensive, heavy, and with age may develop loose-fitting lids that may not protect from moisture, dust, or other pests.

Wood-filled polymers are known. U.S. Pat. No. 5,539,027 describes a process for manufacturing wood fiber composite structural materials. The '027 patent discloses the composite as a replacement for wood structural members having a high resistance to rot. However, the wood-filled polymer provides no properties to repel insects, and it therefore does not protect clothing stored within a tote made from such a wood-filled polymer.

### BRIEF DESCRIPTION OF THE DRAWING

Objects, features, and advantages of the present invention will become apparent upon reading the following description in conjunction with the figure, in which:

FIG. 1 shows a front view of a first example of a plastic tote made from a cedar-filled material.

FIG. 2 shows a top view of the tote of FIG. 1.

FIG. 3 shows a side view of the tote of FIG. 1.

FIG. 4 shows a perspective view of the tote of FIG. 1.

FIG. 5 shows a front view of a second example of a plastic tote made from a cedar-filled material.

FIG. 6 shows a top view of the tote of FIG. 5.

FIG. 7 shows a side view of the tote of FIG. 5.

FIG. 8 shows a perspective view of the tote of FIG. 5.

FIG. 9 shows a front view of a third example of a plastic tote made from a cedar-filled material.

FIG. 10 shows a top view of the tote of FIG. 9.

FIG. 11 shows a side view of the tote of FIG. 9.

FIG. 12 shows a bottom view of the tote of FIG. 9.

FIG. 13 shows a perspective view of the tote of FIG. 9.

FIG. 14 is a flow chart of an example of a process of manufacturing a cedar-filled material.

### DETAILED DESCRIPTION OF THE DISCLOSURE

A plastic tote of cedar-filled material may provide long-term storage for clothing or other cloth items. It can have the advantage of being a tight-fitting, waterproof container made from a polymer, and can benefit from the insect resistance and pleasant aroma of cedar wood.

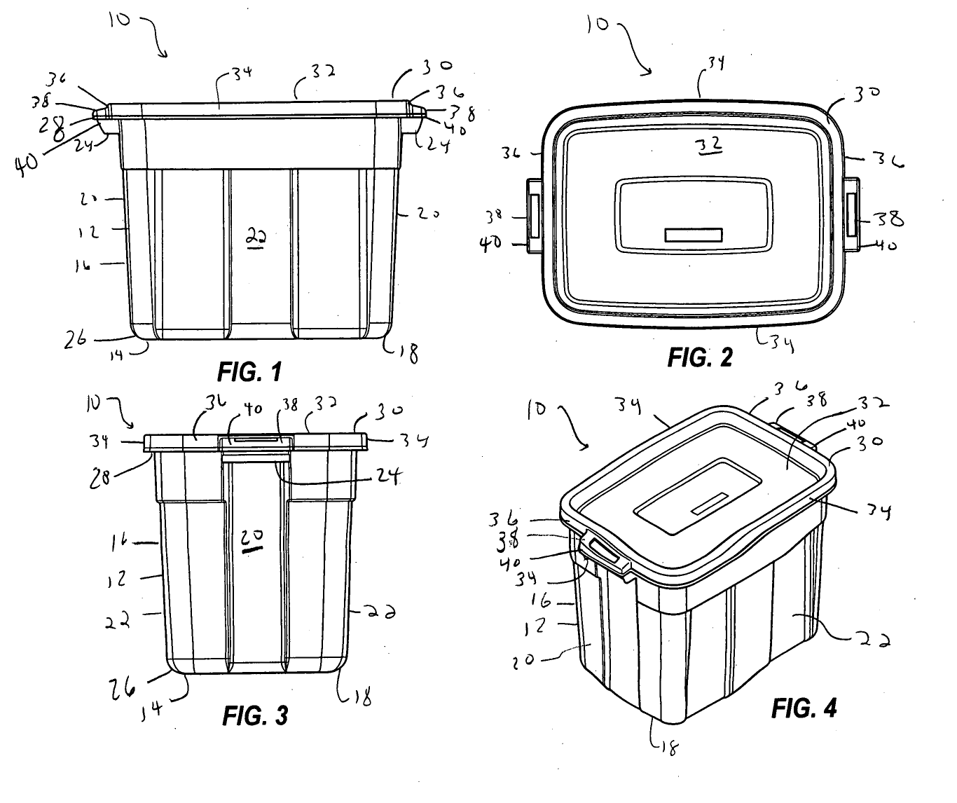

A first example of a tote 10 made from cedar-filled plastic is shown in FIGS. 1-4. The tote 10 includes a base 12 having a bottom panel 14 and a sidewall 16 extending upwardly from an outer perimeter 18 of the bottom panel 14. The bottom panel 14 and the sidewall 16 of the base 12 define a tote interior. In this example, the sidewall 16 includes two opposed end panels 20 and two opposed side panels 22, all of the which can have a stepped or ribbed construction to improve strength. In other constructions, the sidewall 16 can be circular, oval, or any other suitable shape. Handles 24 extend outwardly from the opposed end panels 20. The sidewall 16 and the bottom panel 14 can intersect at rounded corners 26 to facilitate molding. The sidewall 16 terminates at a top edge 28, which in this example is a rounded lip (not shown).

The tote 10 further includes a lid 30 snap-fitted onto the base 12. The lid 30 includes a top panel 32 and a pair of opposed side panels 34 and a pair of opposed end panels 36 extending downwardly from the top panel 32 that correspond to the side panels 22 and end panels 20 of the base 12. The lid 30 is disposed on the top edge 28 of the sidewall 16 and can enclose the tote interior. In certain applications, the lid 30 can provide an air-tight fit against the top edge 28, although this is not necessary. The lid 30 includes a pair of handles 38 extending outwardly from the end panels 36 that correspond to the handles 24 of the base 12. When the lid 30 is assembled onto the base 12, the handles 24 of the base 12 combine with the handles 38 of the lid 30 to form a pair of handle assemblies 40. The user can then lift the tote 10 by grasping the handle assemblies 40, thereby grasping the base 12 and the lid 30 at the same time.

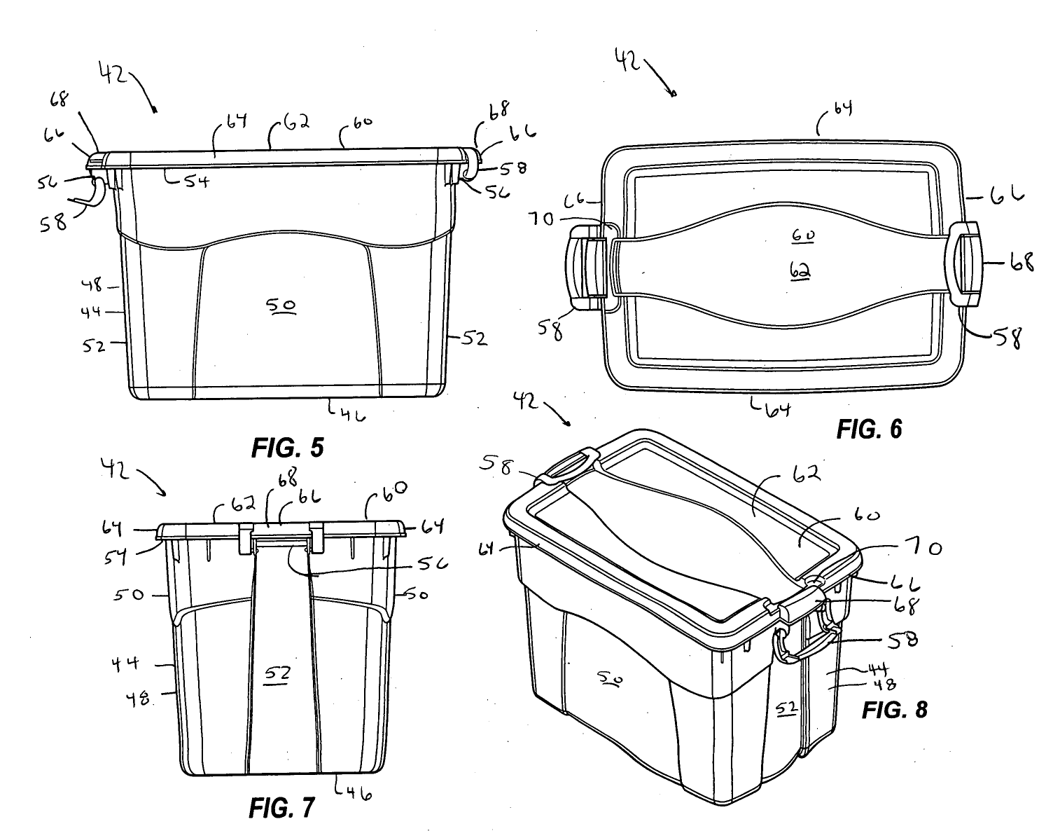

A second example of a tote 42 made with cedar-filled plastic is disclosed in FIGS. 5-8. The second tote 42 is similar in construction to the first tote 10 and includes a base 44 with a bottom panel 46 and a sidewall 48 extending upwardly from the bottom panel 46. The base 44 defines a tote interior. The sidewall 48 has two opposed side panels 50 and two opposed end panels 52 and terminates at a top edge 54. The top edge 54 is again a rounded lip (not shown). A pair of handles 56 extend outwardly from the end panels 52. Unlike the first example, a clasp 58 is pivotably attached to each end panel 52 in the area of the handle 56.

The tote 42 further includes a lid 60 with a top panel 62 and a pair of opposed side panels 64 and a pair of opposed end panels 66 extending downwardly from the top panel 62 and that correspond to the side panels 50 and end panels 52 of the base 44. The lid 60 is disposed on the top edge 54 of the base 44 and can enclose the tote interior. The lid 60 includes a pair of handles 68 that correspond to the handles 56 of the base 44. The lid 60 further includes recesses 70 in the areas of the handles 68 corresponding to the clasps 58 such that when the lid 60 is disposed on the base 44, each clasp 58 can be pivoted over the lid 60 and snap-fit into a respective recess 70. The lid 60 is thereby releasably locked to the base 44, and the user can lift the tote 42 by grasping the base 44 and the lid 70 at the same time.

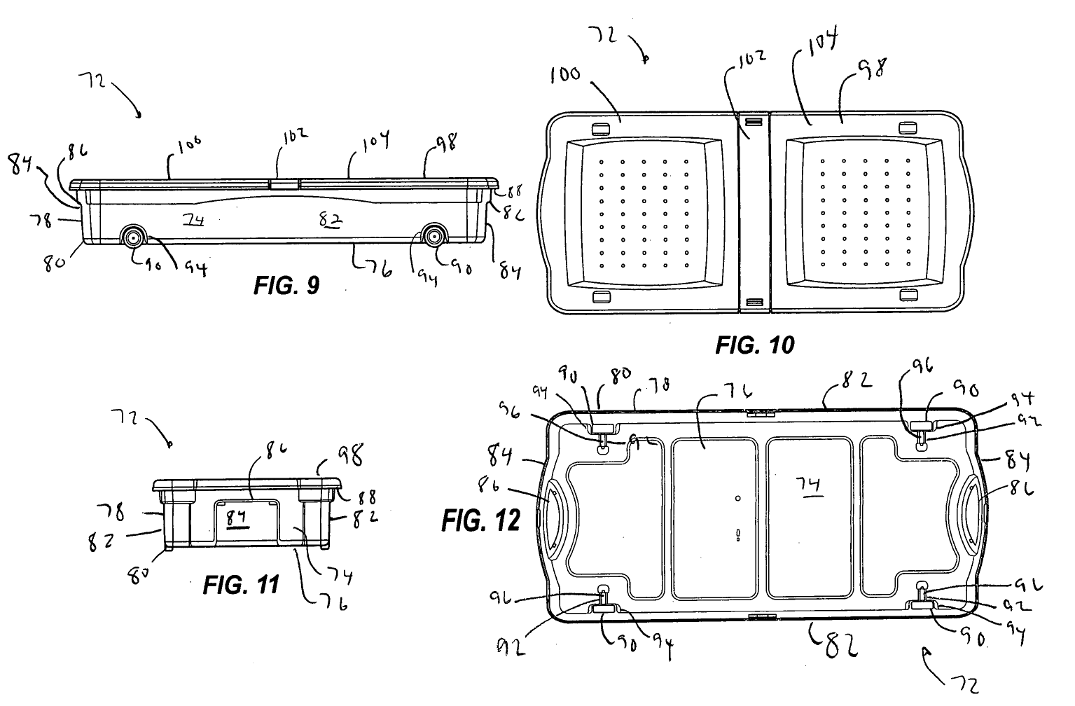

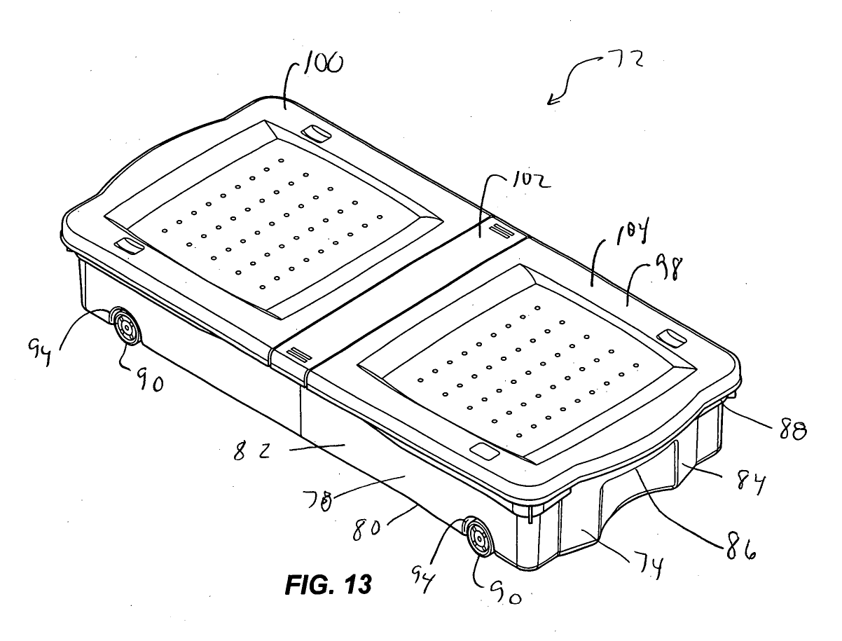

A third example of a tote 72 made with cedar-filled plastic is shown in FIGS. 9-13. The third tote 72 is a slightly different construction as it is designed for storage under a user's bed. Accordingly, it is much wider and longer than it is tall. The tote 72 includes a base 74 having a bottom panel 76 and a sidewall 78 extending upwardly from an outer perimeter 80 of the bottom panel 76 to define a tote interior. The sidewall 78 again includes a pair of opposed side panels 82 and a pair of opposed end panels 84. Handles 86 extend outwardly from each of the end panels 84. The sidewall 78 terminates at a top edge 88, which again is a rounded lip (not shown).

Four wheels 90 are attached to the base 74. The bottom panel 76 includes four axle recesses 92, and the side panels 82 each include two wheel well recesses 94. Axles 96 attached to the wheels 90 are disposed in the axle recesses 92, and the wheels 90 are disposed in the wheel recesses 94. The wheels 90 and axles 96 are able to rotate in their respective recesses 92, 94, and the tote 72 can be pushed or pulled and rolled on the wheels 90.

The tote 72 further includes a lid 98 disposed on the top edge 88 of the base 74 to enclose the tote interior. The lid 98 includes a left panel 100 pivotably connected to a central panel 102, and a right panel 104 pivotably connected to the central panel 102. The central panel 102 is snap-fit to the base 74 such that both the left panel 100 and the right panel 104 may be pivoted upwardly away from the base 74 to allow access to the tote interior while the central panel 102 remains attached to the base 74. In this manner, a user can easily access the interior of the tote 72 without having to remove the lid 98 completely. The left panel 100 and the right panel 104 can be either snap-fit onto the base 74 or simply disposed over the base. The central panel 102 can also be attached to the base 74 in other ways, such as adhesive, fasteners, or the like.

The totes 10, 42, 72 are generally manufactured by injection molding the individual parts (i.e., in the first example the base 12 and the lid 30) with a compounded cedar wood/polymer and then assembling the parts together in a known manner. Plastic totes made from various polymer materials such as linear low density polyethylene (LLDPE), impact and random clarified polypropylene (PP), and high-density polypropylene (HDPE), have good long-term structural integrity, tight-fitting lids, and excellent resistance to water, insects, and other pests. The various polymers noted above and others may be compounded with natural aromatic cedar to provide a cedar wood/polymer that may be used in forming finished articles that can also provide insect repellence. Different plastic molding processes such as blow molding, structural foam molding, and thermoforming may also be used.

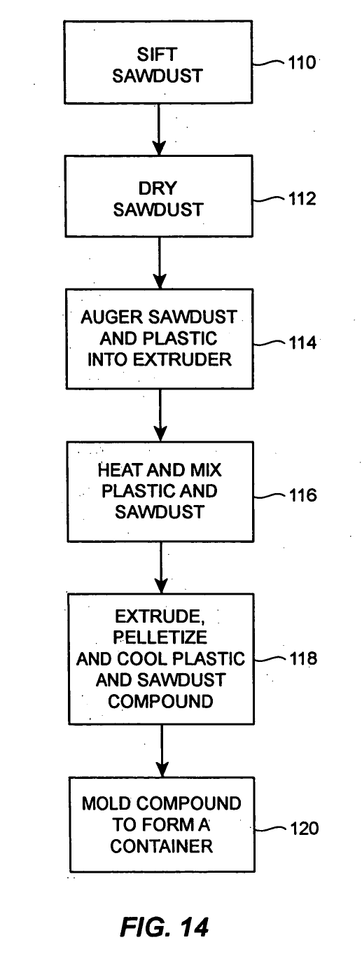

Referring now to FIG. 14, a flowchart of an example of a manufacturing process of the plastic mixture is shown. To manufacture the compounded polymer, a first step 110 includes sifting a batch of cedar sawdust to remove large pieces. In this example, the cedar sawdust is sifted through a 40 mesh screen. A second step 112 includes drying the cedar wood sawdust batch to approximately 1% water by weight in a commercial dryer. In a third step 114, the dried cedar sawdust is then placed in an auger, and pellets of LLDPE are placed in a second auger that is substantially the same size as the first auger. The first and second auger have an output directed into an extruder. The second auger is driven approximately 9 times faster than the first auger such that the extruder receives approximately 90% LLDPE and 10% cedar sawdust by volume. Other sizes and speeds of augers can be used to provide the desired ratio. In a fourth step 116, the extruder heats the pellets of LLDPE until they are molten and mixes the sawdust with the molten LLDPE. The extruder should limit the temperature of the mixture to approximately 380° F. to avoid damaging the cedar wood. The extruder then drives the mixture through a plurality of openings into an underwater bath. A rotating blade severs the mixture into a plurality of pellets in a fifth step 118 and the bath cools the pellets. The pellets are then transferred out of the bath to dry. In a sixth step 120, these cedar wood-filled pellets can then be used to construct the totes 10, 42, 72 or portions thereof using, for example, the molding processes mentioned above.

In another example not shown, inserts may also be formed using this cedar wood/polymer compound for use in such finished articles such as storage tote bins, chests, and other storage items. These inserts can be dimensioned to generally conform to the interior dimensions of already existing totes, containers, or the like. In another example, flat panels of the cedar-wood/polymer may be used in non-standard sized containers to retrofit existing containers. These panels may be cut by the consumer to fit the insides of the containers and assembled to the containers.

A tote made from the cedar sawdust-infused LLDPE can provide benefits over and above a tote made from standard LLDPE. The totes disclosed above benefit from the inclusion of the cedar sawdust because the cedar sawdust repels certain insects known to damage clothing. Accordingly, totes 10, 42, 72 or any other container made from the combination cedar sawdust-LLDPE protects clothing stored therein from certain destructive insects.

In a test to determine the efficacy of the cedar-filled plastic, a standard start box was connected to a first box made with cedar-filled plastic by a first flexible tube. The standard start box was also connected to a second standard box by a second flexible tube. Both the cedar-filled box and the second standard box were provisioned with insect harborage, food and water, while the start box contained no provisions. Accordingly, insects placed in the start box could choose to go through either the first tube to the cedar-filled box or through the second tube to the second standard box to reach their provisions. Insects were placed in the start box, with the number of insects in each box tallied and analyzed 4, 8, 24, and 48 hours later. Three iterations were performed.

In a first experiment, 20 adult clothes moths (Tineola bisselliella) were placed in the start box. The following is a chart that indicates the performance of the cedar-filled tote relative to the standard tote in repelling clothes moths. As can be seen, in each iteration, moths traveled to the standard tote in increasing numbers as time passed. For example, in the first iteration, after four hours, one moth had entered the standard tote, after 8 hours, 5 moths had entered the standard tote, after 24 hours, 14 moths had entered the standard tote, and after 48 hours, 18 moths had entered the standard tote. On the contrary, in this experiment, not a single moth traveled into the cedar-filled tote, even after 48 hours.

| | | Insects in | Insects in |
|---|---|---|---|
| | | cedar-filled | standard |
| Iteration | Hours | tote | tote |
| 1 | 4 | 0 | 1 |
| | 8 | 0 | 5 |
| | 24 | 0 | 14 |
| | 48 | 0 | 18 |
| 2 | 4 | 0 | 0 |
| | 8 | 0 | 5 |
| | 24 | 0 | 9 |
| | 48 | 0 | 9 |
| 3 | 4 | 0 | 1 |
| | 8 | 0 | 4 |
| | 24 | 0 | 11 |
| | 48 | 0 | 16 |

The same experiment was performed with firebrats (thermobia domestica) instead of clothes moths. The results, as shown in this chart, are similar.

| | | Insects in | Insects in |
|---|---|---|---|
| | | cedar-filled | standard |
| Iteration | Hours | tote | tote |
| 1 | 4 | 0 | 0 |
| | 8 | 0 | 1 |
| | 24 | 0 | 15 |
| | 48 | 0 | 25 |
| 2 | 4 | 0 | 0 |
| | 8 | 0 | 1 |
| | 24 | 0 | 10 |
| | 48 | 0 | 18 |
| 3 | 4 | 0 | 0 |
| | 8 | 0 | 0 |
| | 24 | 0 | 22 |
| | 48 | 0 | 23 |

While in these two experiments no insects entered the cedar filled totes, no claim is made that the totes are absolutely 100% effective at all times against these particular insects. In fact, these tests were repeated several times, and in certain instances a small number of these insects did enter the cedar-filled tote. However, the results of the tests are provided to show that the cedar-filled plastic is effective in repelling certain insects in comparison to a standard plastic. Accordingly, by compounding cedar saw dust and a polymer for use in molded containers, the benefits of a cedar chest may be brought to the market at prices and configurations previously unavailable to mass markets because of the cost associated with cedar chest manufacturing. By using the cedar-wood/polymer to make inserts and panels as described, the technology may be made available to existing containers as well. Totes made from such a compound can repel certain insects that may otherwise invade the tote and destroy the contents held therein.

While a ratio of 10% cedar sawdust is disclosed, the ratio of cedar sawdust to plastic can vary considerably and still function to repel certain insects. For example, it is believed that for the disclosed totes 10, 42, 72, mixtures of about 2-20% cedar sawdust both repel insects and also allow the resulting plastic panel to maintain its strength. The mixture can be easily varied by changing the relative augur speeds. Further, other containers or other items made from a compound of cedar wood sawdust and a polymer may be effective to repel insects outside of the 2-20% range. In short, any ratio of cedar wood sawdust to polymer that maintains the integrity of the unit while being effective to repel against the above-noted insects is desirable. Where a cedar-filled tote reduces the amount of insect infestation of either of the above-noted insects in the container by about half relative to a tote of similar dimensions but constructed of standard materials, such a container or other item is considered to have an amount of cedar wood sawdust that is effective in repelling insects.

Although certain plastic storage containers and totes have been described herein in accordance with the teachings of the present disclosure, the scope of coverage of this patent is not limited thereto. Virtually any item normally made with plastic can also be made with cedar-filled plastic. Accordingly, this patent covers all embodiments of the teachings of the disclosure that fairly fall within the claims and the scope of permissible equivalents.

What is claimed is:

1. A tote with insect-repellant properties, comprising:
a base;
a sidewall coupled to the base and at least in part defining a tote interior; and
wherein at least one of the base and the sidewall is constructed from a polymer compound including a polymer and cedar wood, wherein the polymer compound has a ratio of cedar wood to polymer such that the compound is effective to repel insects from within the tote interior.

2. The tote of claim 1, wherein the polymer is LDPE, HDPE, or PP.

3. The tote of claim 1, wherein the polymer compound is between 2% and 20% cedar wood by volume.

4. The tote of claim 1, wherein the cedar wood is in the form of sawdust.

5. The tote of claim 4, wherein the cedar wood sawdust is dried.

6. The tote of claim 1, wherein the tote is manufactured by injection molding, blow molding, structural foam molding, or thermoforming.

7. The tote of claim 1, further comprising a lid that can be selectively disposed on an upper portion of the sidewall to enclose the tote interior.

8. A method of manufacturing a container with insect-repellent properties, comprising:
mixing a compound of cedar sawdust and polymer;
extruding and pelletizing the compound; and
molding the compound into at least a portion of a container,
wherein the compound has a ratio of cedar wood sawdust to polymer such that the compound is effective to repel insects.

9. The method of claim 8, wherein the mixing step including mixing the compound in an extruder.

10. The method of claim 8, further comprising drying the cedar sawdust.

11. The method of claim 8, further comprising sifting the cedar sawdust.

12. The method of claim 8, wherein the mixing step includes the compound being 2% to 20% cedar sawdust by volume.

13. The method of claim 8, wherein the mixing step includes the polymer being LDPE, HDPE, or PP.

14. The method of claim 8, wherein the molding step includes molding a base comprising a bottom panel and a sidewall coupled to the base.

15. The method of claim 8, wherein the molding step includes injection molding, blow molding, structural foam molding, or thermoforming.

16. A method of manufacturing an insect-repellent compound, comprising:
providing a polymer;
adding cedar sawdust to the polymer in ratio of 2% to 20% cedar wood sawdust by volume;
mixing the cedar sawdust with the polymer to form a compound; and
processing the compound through an extruder.

17. The method of claim 16, wherein the providing step includes the polymer being LDPE, HDPE, or PP.

18. The method of claim 16, further comprising drying the cedar sawdust.

19. The method of claim 16, further comprising sifting the cedar sawdust.

20. An insect-repelling compound, comprising:
a polymer; and
cedar wood saw dust;
wherein the compound has a ratio of 2% to 20% cedar wood sawdust by volume.

21. The compound of claim 20, wherein the polymer is LDPE, HDPE, or PP.
